(19) United States
(12) Patent Application Publication
(10) Pub. No.: US 2025/0158316 A1
(43) Pub. Date: May 15, 2025

(54) CONNECTOR

(71) Applicant: Yazaki Corporation, Tokyo (JP)

(72) Inventors: Yoshifumi SHINMI, Shizuoka (JP); Ryo WATANABE, Shizuoka (JP); Miho SUZUKI, Shizuoka (JP); Kazuki TSUCHIDA, Shizuoka (JP)

(73) Assignee: Yazaki Corporation, Tokyo (JP)

(21) Appl. No.: 18/944,686

(22) Filed: Nov. 12, 2024

(30) Foreign Application Priority Data
Nov. 15, 2023 (JP) 2023-194550

(51) Int. Cl. H01R 13/506; H01R 11/28; H01R 13/424

(52) U.S. Cl. CPC H01R 13/506; H01R 11/28; H01R 13/424; H01R 2201/10

(57) ABSTRACT

A connector includes a plurality of terminals, an inner housing, an outer housing, and a front holder. Each of the terminals includes a connecting unit to be connected to an external terminal of an external connector, and a joining unit to which a core wire of an electric wire is joined by ultrasonic wave. The inner housing includes a plurality of first receiving units each of which receives the connecting unit of the corresponding terminal. The outer housing includes a second receiving unit and a third receiving unit. The second receiving unit receives the plurality of the first receiving units of the inner housing. The third receiving unit receives the joining unit of each of the terminals exposed from the inner housing. The front holder fixes the inner housing by sandwiching the inner housing between the front holder and the outer housing.

### CROSS-REFERENCE TO RELATED APPLICATIONS

The present application is based on, and claims priority from Japanese Patent Application No. 2023-194550, filed on Nov. 15, 2023, the entire contents of which are incorporated herein by reference.

### TECHNICAL FIELD

The disclosure relates to a connector.

### BACKGROUND

Conventionally, there has been known a connector provided with a terminal crimped on an electric wire.

In a connector disclosed in JP 2020-187920 A, a pair of swaging pieces extending toward a width direction of a terminal from a base part of the terminal, is swaged such that the pair of swaging pieces surrounds an outer circumference of a core wire exposed from an insulation coating of an electric wire, and then is crimped on the core wire. This electrically connect the terminal to the electric wire.

### SUMMARY OF THE INVENTION

In a connector connected to a power supply system in which a multi-phase motor (e.g., three-phase motor) is employed, there is provided a plurality of terminals corresponding to a plurality of electric wires connected to motors. Each electric wire is used to supply the multi-phase motor with an electric current corresponding to each phase.

In such a connector, in a case where each of the plurality of terminals is crimped on the corresponding electric wire, it is required that each terminal is spaced apart from other terminals such that a swaging piece of the terminal does not interfere with swaging pieces of the other terminals.

Further, in such a connector, there is provided a locking mechanism configured to lock an inner housing, which is configured to hold the plurality of terminals therein, to an outer housing. Due to this configuration, it is required that each terminal is spaced apart from the locking mechanism such that an electric wire on which the terminal is crimped does not interfere with the locking mechanism.

Thus, there is a possibility that a space for arranging the plurality of terminals increases in the connector connected to the power supply system in which the multi-phase motor is employed. In the case where the space for arranging the plurality of terminals increases, there is a problem that the connector becomes larger to increase costs for manufacturing the connector.

The disclosure has been made in view of such a conventional problem, and it is an object of the disclosure to provide a connector that can reduce a size of an arrangement space for a plurality of terminals to suppress an increase in manufacturing costs.

According to an aspect of the disclosure, there is provided a connector to be connected to an external connector, and includes a plurality of terminals, an inner housing, an outer housing, and a front holder that fixes the inner housing by sandwiching the inner housing between the front holder and the outer housing. Each of the terminals extends in a first direction in which the connector is to be connected to the external connector. Each of the terminals includes a connecting unit to be connected to an external terminal of the external connector, and a joining unit to which a core wire of an electric wire is joined by ultrasonic wave. The inner housing includes a plurality of first receiving units each of which receives the connecting unit of a corresponding terminal and opens to outside in the first direction. The outer housing includes a second receiving unit that receives the plurality of the first receiving units of the inner housing and opens to outside in the first direction, and a third receiving unit that is connected to the second receiving unit and receives the joining unit of each of the terminals exposed from the inner housing.

According to the disclosure, it is possible to provide a connector that can reduce a size of an arrangement space for a plurality of terminals to suppress an increase in manufacturing costs.

### BRIEF DESCRIPTION OF DRAWINGS

FIG. 1 is a perspective view of a connector according to the present embodiment.

FIG. 2 is an exploded perspective view of the connector according to the present embodiment.

FIG. 3 is a perspective view of a terminal according to the present embodiment.

FIG. 4 is a diagram illustrating a state where core wires of electric wires are respectively joined to terminals according to the present embodiment by ultrasonic wave.

FIG. 5 is a perspective view of an inner housing according to the present embodiment.

FIG. 6 is a partially-exploded perspective view of the connector according to the present embodiment.

FIG. 7 is a perspective view of the connector according to the embodiment which is cut along a thickness direction at the center in a width direction of the connector.

FIG. 8 is a diagram illustrating a fixation of the inner housing according to the present embodiment.

FIG. 9 is a front view of the connector according to the present embodiment.

FIG. 10 is a cross-sectional view taken along an X-X line illustrated in FIG. 9.

FIG. 11 is a diagram illustrating an arrangement of the terminals in the connector according to the present embodiment.

FIG. 12 is a cross-sectional view of a connector according to a comparative example cut along a thickness direction at the center in a width direction of the connector.

### DETAILED DESCRIPTION OF THE INVENTION

Hereinafter, a terminal according to the present embodiment will be described in detail with reference to the drawings. The dimensional ratio of the drawings is exaggerated for the sake of explanation, and may differ from the actual ratio.

### Configuration of Connector

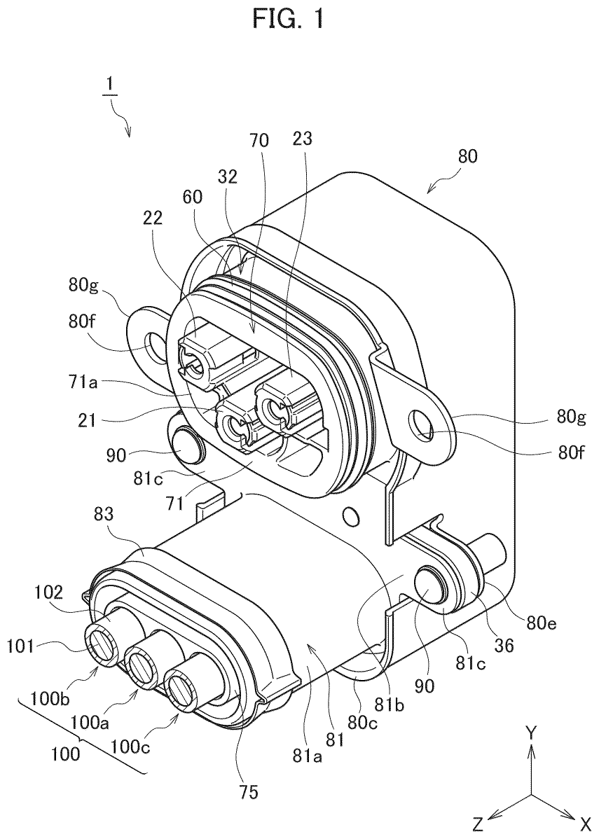

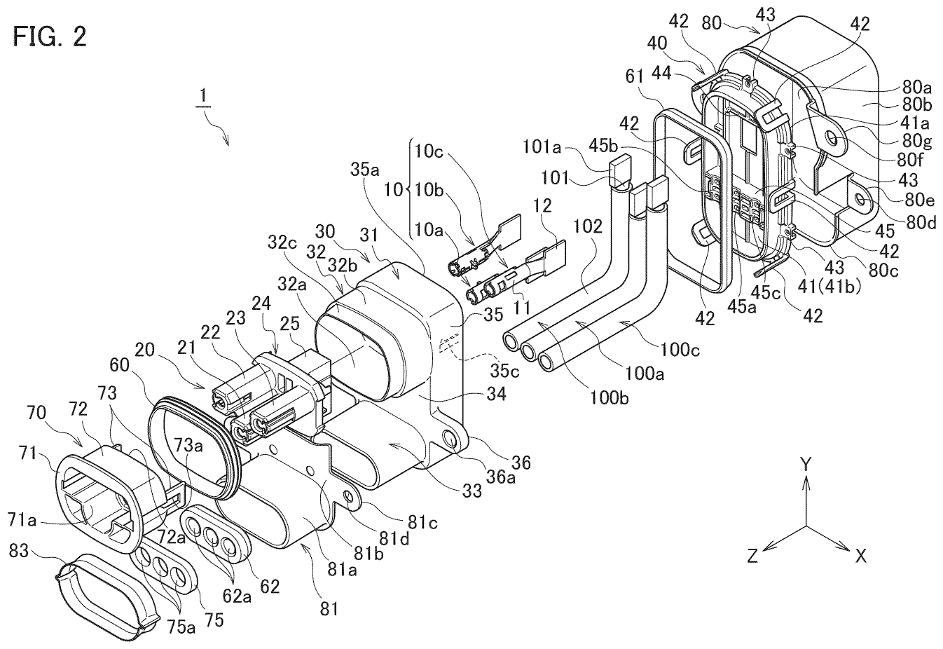

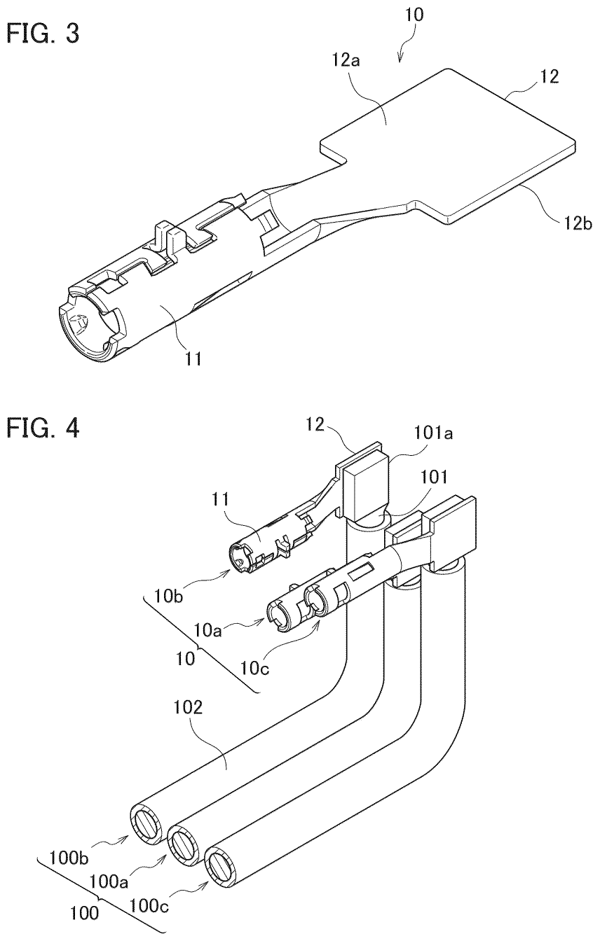

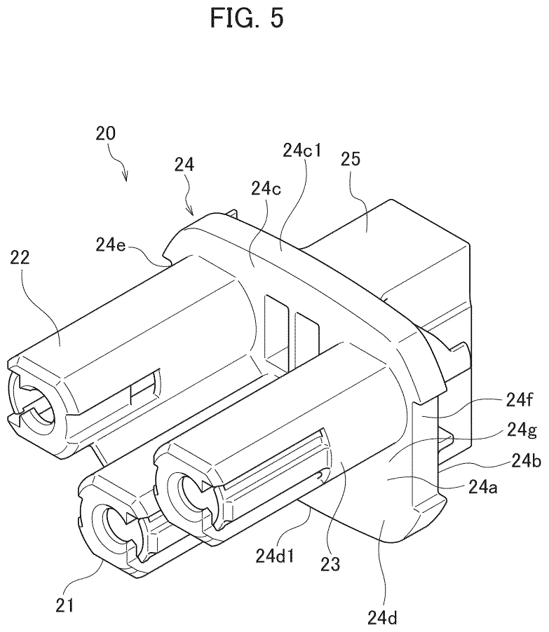

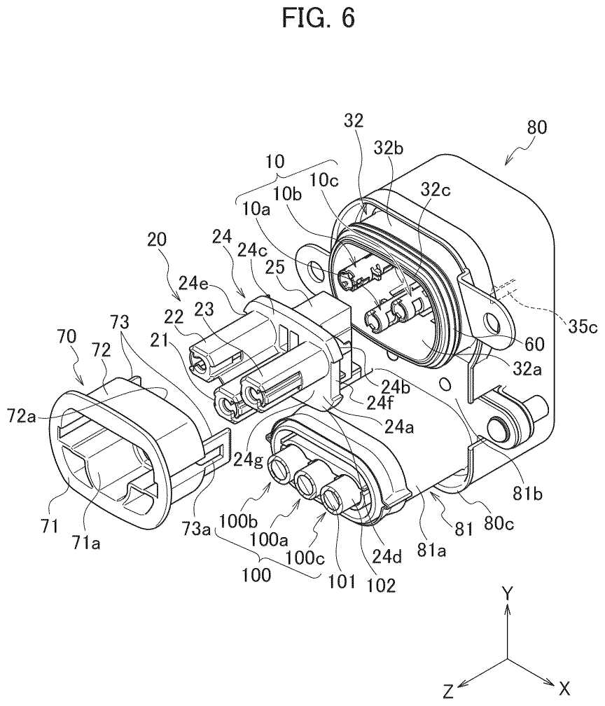

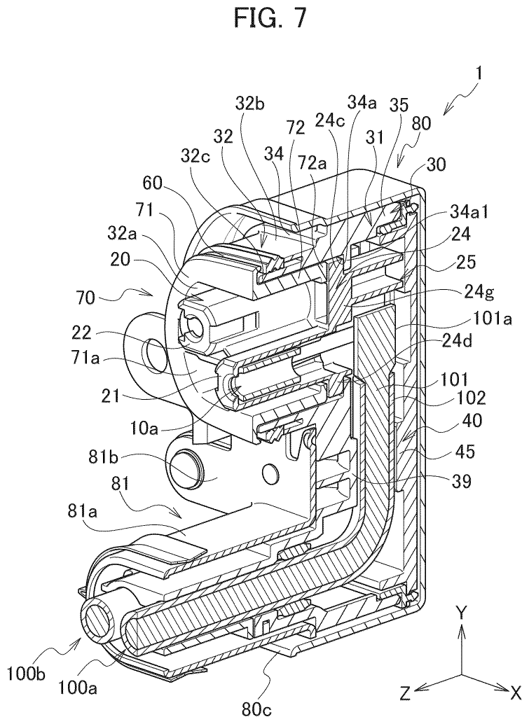

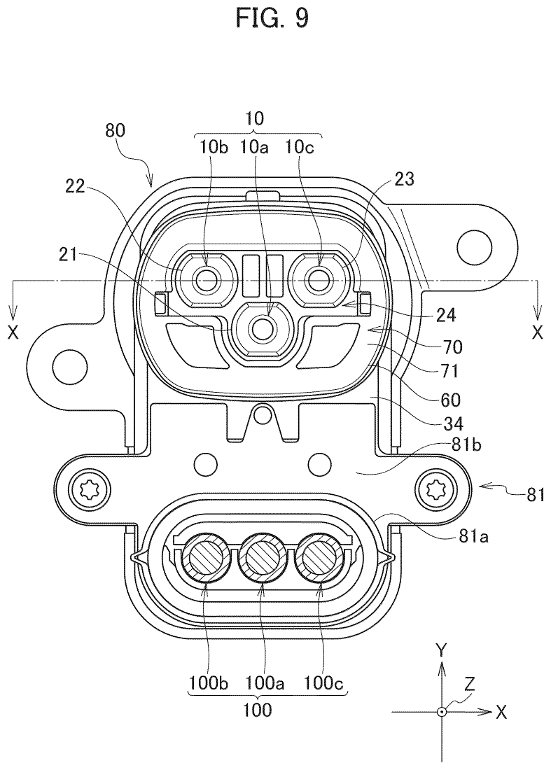

First, a configuration of a connector 1 will be described with reference to FIGS. 1 to 7 and FIG. 9. FIG. 1 is a perspective view of the connector 1. FIG. 2 is an exploded perspective view of the connector 1. FIG. 3 is a perspective view of a terminal 10. FIG. 4 is a diagram illustrating a state where core wires 101 of electric wires 100 are respectively joined to terminals 10 by ultrasonic wave. FIG. 5 is a perspective view of an inner housing 20. FIG. 6 is a partially-exploded perspective view of the connector 1. FIG. 7 is a perspective view of the connector 1 cut along a thickness direction at the center in a width direction of the connector 1. FIG. 9 is a front view of the connector 1.

An X-direction illustrated in FIGS. 1, 2, 6, 7 and 9 corresponds to the width direction of the connector 1. A Y-direction illustrated in FIGS. 1, 2, 6, 7 and 9 corresponds to a height direction of the connector 1, and is orthogonal to the X-direction. A Z-direction illustrated in FIGS. 1, 2, 6, 7 and 9 corresponds to the thickness direction of the connector 1, and is orthogonal to the X-direction and the Y-direction. Note that the thickness direction (Z-direction) of the connector 1 is a direction where the connector 1 is to be connected to an external connector, and is referred to as a first direction.

The connector 1 is a high-voltage connector that can be employed, for example, in a power supply system of a rear motor in an electric vehicle or a hybrid vehicle. In this embodiment, the connector 1 is connected to a power supply system of a three-phase motor as the rear motor (not illustrated). Note that the rear motor is not limited to the three-phase motor. The rear moto may be a motor with more than three-phases. The rear motor with three-phases or more is collectively referred to as a multi-phase motor.

As the power supply system of the three-phase motor, there are three electric wires 100 in advance: a first electric wire 100a, a second electric wire 100b, and a third electric wire 100c. The first electric wire 100a is an electric wire for U phase. The second electric wire 100b is an electric wire for V phase. The third electric wire 100c is an electric wire for W phase.

Each electric wire 100 has a core wire 101 which is a conductor, and a coating part 102 which is an insulator covering the core wire 101. One end of each electric wire 100 is connected to the three-phase motor, and the other end of each electric wire 100 is connected to the connector 1. In each electric wire 100, at the other end to be connected to the connector 1, the coating part 102 is removed to expose an end part 101a of the core wire 101 composed of multiple strands. FIGS. 2 and 4 illustrate the end part 101a formed in a flat plate shape by connecting the multiple strands to each other at the end part 101a of the core wire 101 using ultrasonic joining as will be described later.

The connector 1 includes a plurality of terminals 10, an inner housing 20, an outer housing 30, and a rear cover 40 as element groups related to electrical connections.

In this embodiment, there are three terminals 10: a first terminal 10a, a second terminal 10b, and a third terminal 10c, corresponding to the three-phase motor. The first terminal 10a is connected to an end of the first electric wire 100a. The second terminal 10b is connected to an end of the second electric wire 100b. The third terminal 10c is connected to an end of the third electric wire 100c.

Each of the three terminals 10 is a metal female terminal with the same shape as the other terminals 10. In the connector 1, each of the three terminals 10 extends toward a direction in which the connector 1 is to be connected to an external connector. Each of the three terminals 10 includes a connecting unit 11 and a joining unit 12 (see FIG. 3).

The connecting unit 11 is a tubular member in which a rod-like male terminal as an external terminal which the external connector has, can be inserted. The connecting unit 11 has a plate spring part for pressing a part of the male terminal against an inner wall of the connecting unit 11 to ensure stable continuity with the male terminal inserted therein. The plate spring part may be integrated with the connecting unit 11, or may be a plate spring member separately prepared and previously mounted in the connecting unit 11. This configuration allows the connecting unit 11 to be connected to the external terminal of the external connector.

The joining unit 12 is a flat plate member to which the end part 101a of the core wire 101 in the electric wire 100 is joined. If one end of the connecting unit 11 in an axial direction of the connecting unit 11 is an open end in which the male terminal can be inserted, the joining unit 12 is integrated with the other end of the connecting unit 11 in the axial direction of the connecting unit 11.

As will be described later, in the connector 1, the terminals 10 are received in the inner housing 20 and the outer housing 30. In this state, each of the connecting units 11 is placed such that the axial direction of the connecting unit 11 is parallel to the Z-direction. In this case, the joining unit 12 may be the flat plate member parallel to the Y-direction and the Z-direction. For example, a flat surface shape of the joining unit 12 may be an approximate rectangle in which two of four sides are parallel to the Z-direction and remaining two of the four sides are parallel to the Y-direction.

The joining unit 12 has a first surface 12a and a second surface 12b. The first surface 12a is one surface of the joining unit 12 in the thickness direction of the terminal 10, and is a joining surface to which the end part 101a of the core wire 101 is joined. The second surface 12b is the other surface of the joining unit 12 in the thickness direction of the terminal 10, and is a free surface to which nothing is joined.

The end part 101a of the core wire 101 is joined to the first surface 12a of the joining unit 12 by ultrasonic wave. The ultrasonic joining is employed to join the end part 101a to the first surface 12a by sandwiching the end part 101a and the joining unit 12 between a horn and an anvil (both not illustrated) in a state where the end part 101a is in contact with the first surface 12a, and then applying ultrasonic vibration from the horn.

During the ultrasonic joining, for each terminal 10, a direction from the joining unit 12 to the connecting unit 11 along the axial direction of the connecting unit 11 and a direction from the end part 101a on the joining unit 12 to a main body of the electric wire 100, intersect at a 90 degree angle (see FIG. 4). In other words, in the connector 1, the end part 101a is placed in a posture along the Y-direction with respect to the first surface 12a of the joining unit 12 when the axial direction of the connecting unit 11 is parallel to the Z direction. In this case, each electric wire 100 extends from the end part 101a toward a direction opposite to the Y-direction when the end part 101a on the joining unit 12 is a starting point.

Here, an uneven part is formed at least on a surface of the horn or a surface of the anvil to be in contact with the end part 101a in order to efficiently transfer ultrasonic vibration to the end part 101a to be joined. Specifically, the uneven part has a knurled shape in which straight peaks and straight valleys parallel to each other are arranged alternately and continuously. As illustrated in FIGS. 2 and 4, the end part 101a joined to the first surface 12a by ultrasonic wave has the flat plate shape which is an approximate rectangle.

If a portion of the end part 101a to be contact with the first surface 12a by ultrasonic joining is an inner surface of the end part 101a, the shape of the uneven part formed on the surface of the horn or the surface of the anvil is transferred to an outer surface of the end part 101a opposite to the inner surface. In other words, the uneven part having the knurled shape (not illustrated) is formed on the outer surface of the end part 101a.

Note that before starting ultrasonic joining, the end part 101a of the core wire 101 may be formed into the flat plate shape.

The inner housing 20 is made of synthetic resin, and is an insulating member that protects each of the three terminals 10 by holding them therein. The inner housing 20 includes a first terminal receiving unit 21, a second terminal receiving unit 22, a third terminal receiving unit 23, a base unit 24, and a reinforcing structure unit 25 (see FIG. 5).

The first terminal receiving unit 21 is a tubular member in which the connecting unit 11 of the first terminal 10a is received. The second terminal receiving unit 22 is a tubular member in which the connecting unit 11 of the second terminal 10b is received. The third terminal receiving unit 23 is a tubular member in which the connecting unit 11 of the third terminal 10c is received. In the connector 1, each of the first terminal receiving unit 21, the second terminal receiving unit 22, and the third terminal receiving unit 23 receives the corresponding connecting unit 11 such that an opening direction of the corresponding connecting unit 11 to be received inside (that is, a direction opposite to a direction in which the male terminal is to be inserted) matches the Z-direction. A tip of each of the first terminal receiving unit 21, the second terminal receiving unit 22, and the third terminal receiving unit 23 is open in the Z-direction, and does not obstruct the entry of the male terminal into the corresponding connecting unit 11.

Note that the first terminal receiving unit 21, the second terminal receiving unit 22, and the third terminal receiving unit 23 are also referred to as first receiving units, respectively.

In the present embodiment, in the connector 1, the first terminal receiving unit 21, the second terminal receiving unit 22, and the third terminal receiving unit 23 are two-tiered along the Y-direction (see FIG. 9), as one example. For example, the first terminal receiving unit 21 is arranged in a lower tier in the Y-direction, and the second terminal receiving unit 22 and the third terminal receiving unit 23 are arranged in an upper tier in the Y-direction. In the X-direction, the first terminal receiving unit 21 is arranged in a middle position between the second terminal receiving unit 22 and the third terminal receiving unit 23.

Thus, when one of the first terminal receiving unit 21, the second terminal receiving unit 22, and the third terminal receiving unit 23 is arranged in one of the two stages, another terminal receiving unit adjacent to the one terminal receiving unit in the X-direction is arranged in the other of two stages.

The base unit 24 is a flat plate member that supports the first terminal receiving unit 21, the second terminal receiving unit 22, and the third terminal receiving unit 23 (see FIG. 5). The base unit 24 has a front surface 24a and a back surface 24b. In the connector 1, the front surface 24a is a surface of the base unit 24 facing the Z-direction, and the back surface 24b is a surface of the base unit 24 facing the direction opposite to the Z-direction. In the connector 1, an internal space of each of the first terminal receiving unit 21, the second terminal receiving unit 22, and the third terminal receiving unit 23 is open in the direction opposite to the Z-direction at a side of the back surface 24b.

The base unit 24 further has a first protruding part 24c, a second protruding part 24d, a first groove part 24e, a second groove part 24f, and a support part 24g. The support part 24g is a main body of the base unit 24, and supports root ends of the first terminal receiving unit 21, the second terminal receiving unit 22, and the third terminal receiving unit 23 at a side of the front surface 24a. The first terminal receiving unit 21, the second terminal receiving unit 22, and the third terminal receiving unit 23 penetrate through the support part 24g. The first protruding part 24c protrudes outwardly from an upper end of the support part 24g. The second protruding part 24d protrudes outwardly from a lower end of the support part 24g which is opposite to the upper end of the support part 24g.

In the connector 1, the first protruding part 24c protrudes outwardly from the upper end of the support part 24g along the Y-direction, and the second protruding part 24d protrudes outwardly from the lower end of the support part 24g along the direction opposite to the Y-direction. The direction in which the first protruding part 24c protrudes is not limited to the Y-direction, but can be any direction that intersects the Z-direction. Similarly, the direction in which the second protruding part 24d protrudes is not limited to the direction opposite to the Y-direction, but can be any direction that intersects the Z-direction.

Each of an upper surface 24c1 of the first protruding part 24c and a lower surface 24d1 of the second protruding part 24d is formed to follow a shape of an inner circumference surface of a communicating hole part 34a in a housing main body 31 of the outer housing 30 to be described later. Note that the first protruding part 24c and the second protruding part 24d are also referred to simply as a protruding part. The direction in which the first protruding part 24c protrudes and the direction in which the second protruding part 24d protrudes are also referred to as a second direction.

The first groove part 24e is formed on one side of the support part 24g. One side wall and the other side wall of the first groove part 24e are continuous with the first protruding part 24c and the second protruding part 24d, respectively. The second groove part 24f is formed on the other side of the support part 24g. One side wall and the other side wall of the second groove part 24f are continuous with the first protruding part 24c and the second protruding part 24d, respectively. In the connector 1, locking parts 73 in a tubular part 72 of a front holder 70 to be described later, are inserted into the first groove part 24e and the second groove part 24f, respectively.

The reinforcing structure unit 25 is a structure composed of a plurality of reinforcing ribs to ensure a strength of the inner housing 20. The reinforcing structure unit 25 is provided on the back surface 24b of the base unit 24 so as not to interfere with the arrangement of the respective terminals 10 and the respective electric wires 100.

The outer housing 30 is made of synthetic resin, and is an insulating member that protects the entire three terminals 10 by receiving at least a part of the inner housing 20 and the joining units 12 of the respective terminals 10 therein. The outer housing 30 includes the housing main body 31, a connector opening unit 32, and an electric wire leading-out unit 33. Note that the housing main body 31 and the connector opening unit 32 are also referred to as a third receiving unit and a second receiving unit, respectively.

The housing main body 31 is formed in a box-like shape, and has a front wall 34, an annular side wall 35, and a plurality of support pieces 36.

In the connector 1, the front wall 34 is a wall standing in a direction perpendicular to the Z-direction, and supports the connector opening unit 32 and the electric wire leading-out unit 33 such that they are separated from each other in the Y-direction. The front wall 34 has the communicating hole part 34a communicating the interior of the connector opening unit 32 with the interior of the housing main body 31 (see FIG. 7).

In this embodiment, in the connector 1, a cross-sectional shape of the communicating hole part 34a along the X-direction and the Y-direction is the same as the cross-sectional shape of an opening part 32a of the connector opening unit 32 to be described later. In this embodiment, when the inner housing 20 is assembled to the outer housing 30, the communicating hole part 34a receives therein the base unit 24 of the inner housing 20, and the root ends of the first terminal receiving unit 21, the second terminal receiving unit 22, and the third terminal receiving unit 23 which are supported by the base unit 24. Note that the communicating hole part 34a may receives therein only the base unit 24 of the inner housing 20. In this case, the opening part 32a of the connector opening unit 32 receives therein the root ends of the first terminal receiving unit 21, the second terminal receiving unit 22, and the third terminal receiving unit 23. Thus, a thickness of the communicating hole part 34a is set to be equal to or greater than a thickness of the base unit 24 of the inner housing 20.

The communicating hole part 34a has a contacting portion 34a1 (see FIG. 7). The contacting portion 34a1 is formed continuously along an inner circumference surface of one end of the communicating hole part 34a communicating with the interior of the housing main body 31. In the connector 1, the contacting portion 34a1 protrudes inwardly from the inner circumference surface of the one end of the communicating hole part 34a. With this configuration, in the connector 1, a first section of the contacting portion 34a1 facing the first protruding part 24c of the base unit 24 of the inner housing 20 protrudes inwardly from the inner circumference surface of the one end of the communicating hole part 34a along the direction opposite to the Y-direction. In connector 1, a second section of the contacting portion 34a1 facing the second protruding part 24d of the base unit 24 of the inner housing 20 protrudes inwardly from the inner circumference surface of the one end of the communicating hole part 34a along the Y-direction.

The other end of the communicating hole part 34a communicating with the interior of the connector opening unit 32 is also referred to as an end of the housing main body 31 (third receiving unit). In this case, the one end of the communicating hole part 34a communicating with the interior of the housing main body 31 described above, is also referred to as a vicinity of the end of the housing main body 31 (third receiving unit).

In the connector 1, a flat surface shape of the front wall 34 is an approximate rectangle defined by long sides roughly along the Y-direction and short sides roughly along the X-direction. In the front wall 34, a first electric wire contact unit 39 facing a second electric wire contact unit 45 while being separated from it when the rear cover 40 to be described later is attached to the outer housing 30, is mounted on a wall surface facing the interior of the housing main body 31 (see FIG. 7). A shape of the first electric wire contact unit 39 is approximately symmetrical with a shape of the second electric wire contact unit 45 in the Z-direction.

The annular side wall 35 and the front wall 34 form an interior space in which at least the reinforcing structure unit 25 of the inner housing 20 and the joining unit 12 of the respective terminals 10 are received (see FIG. 7). On annular end of the annular side wall 35 is continuous with a periphery of the front wall 34. The other annular end of the annular side wall 35 is an open end 35a forming an opening facing the front wall 34. At the time of an assembly of the connector 1, the three terminals 10, which are respectively connected to ends of the three electric wires 100, are received in the interior of the housing main body 31 through the opening formed on the open end 35a. In the connector 1, the one annular end of the annular side wall 35 is located on a side in the Z-direction, and the other annular end of the annular side wall 35 is located on a side in the direction opposite to the Z-direction.

Two claw parts 35c are provided on an inner wall surface of the annular side wall 35 facing the interior of the housing main body 31 such that the two claw parts 35c are spaced from each other in a circumferential direction (see FIGS. 2 and 6). Specifically, in the connector 1, the two claw parts 35c are formed along the Z-direction on two regions along the Y-direction in the inner wall surface of the annular side wall 35. Note that only one of the two claw parts 35c is illustrated in FIGS. 2 and 6.

The support pieces 36 are provided on an outer wall surface of the annular side wall 35, and have fitting holes 36a each for fitting an annular collar (not illustrated), respectively. The fitting holes 36a penetrate through the support pieces 36, respectively. Note that in the connector 1, the fitting holes 36a penetrate through the support pieces 36 along the Z-direction, respectively.

In the connector 1, the connector opening unit 32 has the opening part 32a formed in a round long hole shape in a cross-sectional surface thereof opening in the Z-direction, and is a tubular member to be fitted to a part of the external connector (not illustrated) when the external connector having the male terminal is connected to the connector 1. The connector opening unit 32 is connected to the housing main body 31, and protrudes from the front wall 34 of the housing mainbody 31 toward the Z-direction. When the inner housing 20 is assembled to the outer housing 30, the connector opening unit 32 receives therein the first terminal receiving unit 21, the second terminal receiving unit 22, and the third terminal receiving unit 23 of the inner housing 20.

The opening part 32a penetrates through the connector opening unit 32 between an outside of the outer housing 30 and an inside of the housing main body 31, and can receive therein the first terminal receiving unit 21, the second terminal receiving unit 22, and the third terminal receiving unit 23 of the inner housing 20. Note that the opening part 32a communicates with the interior of the housing main body 31 via the interior of the communicating hole part 34a. In the opening part 32a formed in the round long hole shape in the cross-sectional surface thereof, a longitudinal direction of the cross-sectional surface is parallel to the X-direction in accordance with an arrangement relationship of the first terminal receiving unit 21, the second terminal receiving unit 22, and the third terminal receiving unit 23 of the inner housing 20.

An outer circumferential surface of the connector opening unit 32 is formed in a stepped shape by a first outer circumferential surface 32b and a second outer circumferential surface 32c. The first outer circumferential surface 32b is an outer circumferential surface located at a side of the housing main body 31 in the connector opening unit 32, and is continuous with the front wall 34 of the housing main body 31. The second circumferential surface 32c is an outer circumferential surface located at a side of an opening of the connector opening unit 32, is formed to be lower by one step than the first outer circumferential surface 32b, and is continuous with the first outer circumferential surface 32b.

In the connector 1, the electric wire leading-out unit 33 is a tubular member for leading out the three electric wires 100 from the interior of the housing main body 31 to an outside of the outer housing 30 through a through space formed in a round long hole shape in a cross-sectional surface thereof opening in the Z-direction. The electric wire leading-out unit 33 is provided to protrude in the Z-direction from the front wall 34 of the housing main body 31. In the cross-sectional surface of the through space formed in the round long hole shape, a longitudinal direction of the cross-sectional surface is parallel to the X-direction such that the three electric wires 100 are aligned in the X-direction in accordance with the arrangement relationship of the first terminal receiving unit 21, the second terminal receiving unit 22, and the third terminal receiving unit 23 in the inner housing 20.

In other words, according to the structure of the outer housing 30, in the connector 1, the direction in which the opening part 32a of the connector opening unit 32 faces, that is, the direction in which the connector 1 is to be connected to the external connector, and the direction in which the three electric wires 100 are led out from the electric wire leading-out unit 33, are along the same direction. In this embodiment, the direction in which the opening part 32a of the connector opening unit 32 faces, and the direction in which the three electric wires 100 are led out from the electric wire leading-out unit 33, are along the Z-direction.

The rear cover 40 is made of synthetic resin, and is an insulating member that covers the opening of the open end 35a in a state where each of the three terminals 10 having the joining units 12 to which the end parts 101a of the core wires 101 of the three electric wires 100 are respectively joined, is received in the housing main body 31 of the outer housing 30. The rear cover 40 includes a main body wall 41, a plurality of locking units 42, a plurality of packing locking units 43, a cover reinforcing rib 44, and the second electric wire contact unit 45.

The main body wall 41 is a flat plate member having an outer peripheral edge 41a which is along the open end 35a of the housing main body 31 in a state where the rear cover 40 is attached to the outer housing 30. An inner wall surface 41b of the main body wall 41 faces the front wall 34 of the housing main body 31 in the state where the rear cover 40 is attached to the outer housing 30.

The locking units 42 are provided on the outer peripheral edge 41a of the main body wall 41 while being spaced apart from each other in a circumferential direction along the outer peripheral edge 41a. An outer surface of the annular side wall 35 of the housing main body 31 is provided with a plurality of locked units (not illustrated). The locking units 42 are respectively locked to the locked units of the annular side wall 35 in the state where the rear cover 40 is attached to the outer housing 30, which prevents the rear cover 40 from falling off the outer housing 30.

The packing locking units 43 are provided on the outer peripheral edge 41a of the main body wall 41 without interfering with the locking units 42 while being spaced apart from each other in the circumferential direction along the outer peripheral edge 41a. A rear cover packing 61 to be described later is provided with a plurality of locked protrusions (not illustrated). The packing locking units 43 are respectively locked to the locked protrusions of the rear cover packing 61 in the state where the rear cover 40 is attached to the outer housing 30, which causes the rear cover 40 to hold the rear cover packing 61.

The cover reinforcing rib 44 is provided on the inner wall surface 41b to ensure a strength of the rear cover 40 without interfering with the arrangements of the three terminals 10 and the three electric wires 100.

The second electric wire contact unit 45 is provided on the inner wall surface 41b, and is a structural member that contacts the respective electric wires 100 in the state where the rear cover 40 is attached to the outer housing 30. The second electric wire contact unit 45 has a first contact groove 45a, a second contact groove 45b, and a third contact groove 45c, each of which an extension direction is along the Y-direction and each of which includes a curved surface that matches a side surface shape of each electric wire 100 that is routed in the housing main body 31. The first contact groove 45a receives and contacts a part of a side surface of the first electric wire 100a. The second contact groove 45b receives and contacts a part of a side surface of the second electric wire 100b. The third contact groove 45c receives and contacts a part of a side surface of the third electric wire 100c.

Here, in the state where the rear cover 40 is attached to the outer housing 30, the first contact groove 45a clamps the first electric wire 100a together with an equivalent contact groove in the housing main body 31. Similarly, the second contact groove 45b clamps the second electric wire 100b together with an equivalent contact groove in the housing main body 31. The third contact groove 45c clamps the third electric wire 100c together with an equivalent contact groove in the housing main body 31. In other words, the second electric wire contact unit 45, as a combination with the first electric wire contact unit 39 of the housing main body 31, holds the respective electric wires 100, thereby constituting an electric wire holding member that prevents vibrations transmitted from an outside through the electric wires 100 from reaching the terminals 10.

The connector 1 includes a unit packing 60, a rear cover packing 61, and a wire packing 62 as a waterproofing member that prevents ingress of water from the outside.

The unit packing 60 is an annular elastic member that is tightly attached to the second outer circumferential surface 32c in line with the second outer circumferential surface 32c of the connector opening unit 32 in the outer housing 30. In a state where the external connector is connected to the connector 1, the unit packing 60 seals between the outer circumferential surface of the connector opening unit 32 and a fitting surface of the external connector.

The rear cover packing 61 is an annular elastic member that is tightly attached to the open end 35a in line with the open end 35a of the housing main body 31 in the outer housing 30. In the state where the rear cover 40 is attached to the outer housing 30, the rear cover packing 61 seals between the open end 35a of the housing main body 31 and the outer peripheral edge 41a of the rear cover 40.

The wire packing 62 is an elastic member formed in a round long flat plate shape that is tightly attached to an inner wall surface in line with the inner wall surface of the electric wire leading-out unit 33 in the outer housing 30. The wire packing 62 has three penetrating holes 62a through which the three electric wires 100 individually penetrate while tightly contacting the three electric wires 100. The wire packing 62 seals between the inner wall surface of the electric wire leading-out unit 33 and the respective electric wires 100 penetrating through the through space of the electric wire leading-put unit 33.

The connector 1 includes the front holder 70 and a rear holder 75 as holding members for various packings.

The front holder 70 is made of synthetic resin, and is attached to the outer housing 30 to prevent the unit packing 60 from falling off the connector opening unit 32. As will be described later, the inner housing 20 is sandwiched and fixed between the front holder 70 and the outer housing 30. The front holder 70 includes a front plate 71, a tubular part 72, and two locked parts 73.

The front plate 71 is a flanged annular plate member that is located on a front end of the connector opening unit 32 when the front holder 70 is attached to the outer housing 30. The front plate 71 has an opening part 71a through which the first terminal receiving unit 21, the second terminal receiving unit 22, and the third terminal receiving unit 23 of the inner housing 20 are exposed to an outside of the connector opening unit 32. At least a part of an outer circumferential part of the front plate 71 faces at least a part of the unit packing 60 attached to the connector opening unit 32 in the Z-direction when the front holder 70 is attached to the outer housing 30. Therefore, even if the unit packing 60 moves toward the front end of the connector opening unit 32, the unit packing 60 is prevented from falling off the connector opening part 32 by contacting the front plate 71, which restricts further movement.

The tubular part 72 is received in the opening part 32a of the connector opening unit 32 when the front holder 70 is attached to the outer housing 30. An open end which is one of open ends of the tubular part 72, is a fixing end continuous with the opening part 71a of the front plate 71. An open end 72a which is the other of the open ends of the tubular part 72, is an opening end toward the interior of the housing main body 31 when the front holder 70 is attached to the outer housing 30. The open end 72a is also referred to as an end edge of the front holder 70. A reinforcing structure unit may be provided the interior of the tubular part 72 to ensure a strength of the front holder 70.

The two locked parts 73 are provided in portions of the tubular part 72, and are spaced apart from each other in a circumferential direction of the tubular part 72. Specifically, in the connector 1, the two locked parts 73 are formed along the Z-direction from the opening end of the tubular part 72. Each of the two locked parts 73 is provided with a locked hole 73a. Two claw parts 35c, which are provided on the inner wall surface of the annular side wall 35 of the outer housing 30, is locked to the two locked parts 73 when the front holder 70 is attached to the outer housing 30. This prevents the front holder 70 from falling off the outer housing 30, and allows the inner housing 20 to be sandwiched and fixed between the outer housing 30 and the front holder 70.

The rear holder 75 is made of synthetic resin, and is attached to the outer housing 30 to prevent the wire packing 62 from falling off the electric wire leading-out unit 33. The rear holder 75 has three penetrating holes 75a which allows the three electric wires 100 to penetrate through the rear holder 75 individually, and is a member formed in a round long flat shape similar to the shape of the wire packing 62. The rear holder 75 is inserted into the through space from a tip side of the electric wire leading-out unit 33, and is supported by the electric wire leading-out unit 33 in a state where the wire packing 62 seals between the inner wall surface of the electric wire leading-out unit 33 and the respective electric wires 100. Thereby, the rear holder 75 prevents the wire packing 62 from falling off the electric wire leading-out unit 33.

The connector 1 includes a upper shell 80, a lower shell 81, and a shield ring 83 as a shield member for shielding noise.

The upper shell 80 is made of metal, and covers the housing main body 31 in the state where the rear cover 40 is attached to the outer housing 30. The upper shell 80 may cover at least a part of the connector opening unit 32 or the electric wire leading-out unit 33 of the outer housing 30 while receiving the housing main body 31. The upper shell 80 is formed in a box shape, and has a bottom wall 80a, an annular side wall 80b, a plurality of first support pieces 80e, and a plurality of second support pieces 80g.

In the connector 1, the bottom wall 80a is a wall member extending in a direction orthogonal to the Z-direction. A planar shape of the bottom wall 80a is an approximate rectangle defined by long sides roughly along the Y-direction and short sides roughly along the X-direction.

An interior space of the upper shell 80 that receives the housing main body 31, is formed by the bottom wall 80a and the annular side wall 80b. One annular end of the annular side wall 80b in the Z-direction is continuous with a peripheral edge of the bottom wall 80a. The other annular end of the annular side wall 80b in the Z-direction is an open end 80c that forms an opening facing the bottom wall 80a. In assembling the connector 1, the housing main body 31 to which the rear cover 40 is attached, is received in the upper shell 80 through the opening formed on the open end 80c.

The first support pieces 80e are provided, for example, as a member formed by bending parts of the annular side wall 80b, and has first penetrating holes 80d in which bolts 90 having inserted in the fitting holes 36a of the outer housing 30 are inserted in assembling the connector 1.

The second support pieces 80g are provided, for example, as a member formed by bending pieces protruding from the open end 80c, and has second penetrating holes 80f in which mounting bolts (not illustrated) are inserted when the connector 1 is mounted to a housing of the external connector.

The lower shell 81 is made of metal, and covers a part of the front wall 34 of the housing main body 31 and the electric wire leading-out unit 33 in the outer housing 30. The lower shell 81 has a tubular part 81a, a flange part 81b, and support pieces 81c.

The tubular part 81a covers the electric wire leading-out unit 33 by receiving the electric wire leading-out unit 33 through a through space thereof which is formed in a round long hole shape in a cross-sectional surface thereof opening in the first direction. One open end of the tubular part 81a is a fixing end continuous with the flange part 81b. The other open end of the tubular part 81a is an opening end that forms an opening through which each of the electric wires 100 is led out from the electric wire leading-out unit 33 outward.

In the connector 1, the flange part 81b is a flat plate member extending in a direction orthogonal to the Z-direction, and covers the part of the front wall 34 by facing the part of the front wall 34.

The support pieces 81c are provided as a member protruding outwardly from an edge of the flange part 81b, and has penetrating holes 81d in which the bolts 90 to be inserted in the fitting holes 36a of the outer housing 30 in assembling the connector 1, are previously inserted.

The shield ring 83 is a fastening member, which is made of metal, for crimping the shield braid (not illustrated) to an outer circumference surface of the tubular part 81a of the lower shell 81. The shield braid is a metal braid of which one part covers a tip of the tubular part 81a and the other part wraps around the three electric wires 100 led out outward from the tubular part 81a in an integrated manner.

The connector 1 includes the bolts 90 (see FIG. 1) and collars (not illustrated) previously fitted into the fitting holes 36a of the outer housing 30, as a member for assembling respective components. As described above, the penetrating holes 81d are formed on the support pieces 81c of the lower shell 81, respectively. The collars are fitted into the fitting holes 36a of the outer housing 30. The first penetrating holes 80d are formed on the first support pieces 80e of the upper shell 80, respectively. The bolts 90 are inserted in the penetrating holes 81d, the collars of the fitting holes 36a and the first penetrating holes 80d and then be fastened, which integrally assembles the lower shell 81, the outer housing 30, and the upper shell 80.

### Fixation of Inner Housing

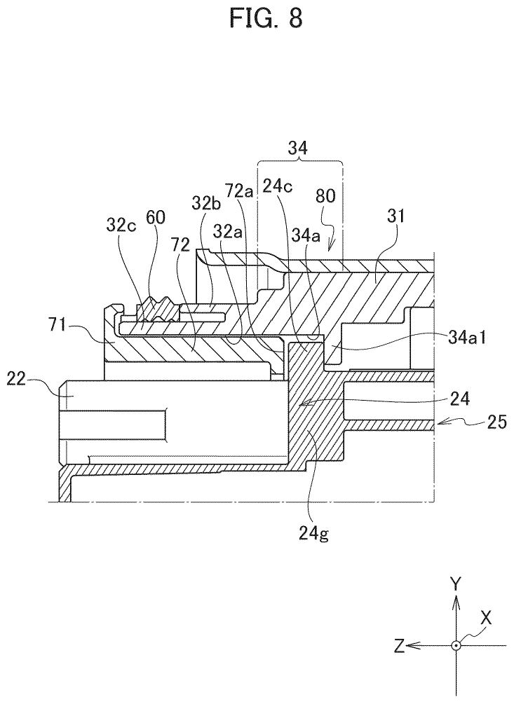

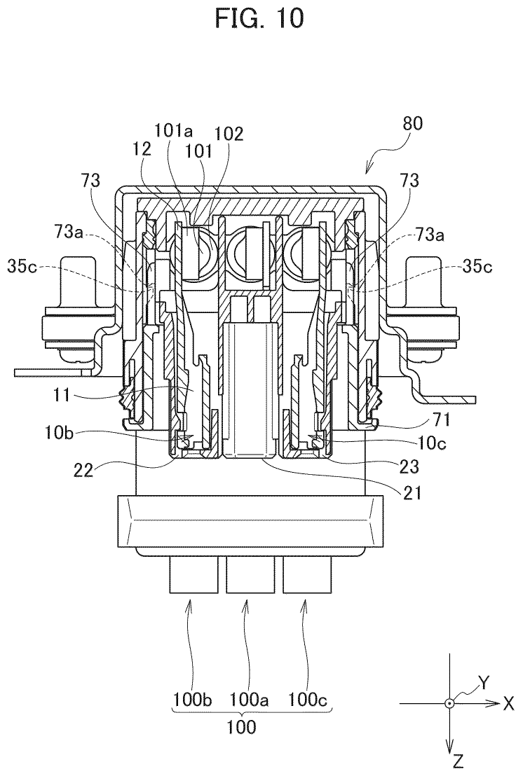

Next, a fixation of the inner housing 20 will be described with reference to FIGS. 6 to 10. FIG. 8 is a diagram illustrating the fixation of the inner housing 20. FIG. 10 is a cross-sectional view taken along an X-X line illustrated in FIG. 9. An X-direction, a Y-direction, and a Z-direction illustrated in FIGS. 8 and 10 are the same as the X-direction, the Y-direction, and the Z-direction illustrated in FIG. 2.

When assembling the connector 1, the three terminals 10 in which the end parts 101a of the core wires 101 of the electric wires 100 are joined to the joining units 12, are placed in the outer housing 30, and the unit packing 60 is attached to the second outer circumferential surface 32c of the connector opening unit 32 of the outer housing 30. In this state, the inner housing 20 is inserted into the opening part 32a of the connector opening unit 32 of the outer housing 30 (see FIG. 6). When the inner housing 20 is inserted into the opening part 32a, the connecting units 11 of the three terminals 10 exposed outward from the opening part 32a are received in the first terminal receiving unit 21, the second terminal receiving unit 22, and third terminal receiving unit 23 of the inner housing 20, respectively.

When the inner housing 20 is further inserted into the opening part 32a, the reinforcing structure unit 25 is inserted into the interior of the housing main body 31, and the base unit 24 is inserted into the interior of the communicating hole part 34a of the front wall 34 of the housing main body 31 (see FIGS. 7 and 8). The inner housing 20 is inserted into the opening part 32a of the connector opening unit 32 until the first protruding part 24c and the second protruding part 24d of the base unit 24 contact the contacting portion 34a1 provided on the inner circumferential surface of the communicating hole part 34a of the front wall 34.

When the inner housing 20 has been inserted into the opening part 32a, the front holder 70 is inserted into the opening part 32a of the connector opening unit 32 of the outer housing 30. At this time, the first terminal receiving unit 21, the second terminal receiving unit 22, and the third terminal receiving unit 23 of the inner housing 20 are placed inside the tubular part 72 of the front holder 70 from the open end 72a of the tubular part 72. The two locked parts 73 of the front holder 70 are inserted into the first groove part 24e and the second groove part 24f of the base unit 24 of the inner housing 20, respectively, and move inside the first groove part 24e and the second groove part 24f.

When the opening end 72a of the tubular part 72 of the front holder 70 abuts against the first protruding part 24c and the second protruding part 24d of the base unit 24 of the inner housing 20, the first protruding part 24c and the second protruding part 24d of the base unit 24 are pressed against the contacting portion 34a1 of the communicating hole part 34a (see FIGS. 7 and 8). At this time, the two claw parts 35c, which are provided on the inner wall surface of the annular side wall 35 of the outer housing 30, are inserted into the locked holes 73a of the two locked parts 73 of the front holder 70, and then the two claw parts 35c are locked to the two locked parts 73, respectively (see FIG. 10).

As a result, the front holder 70 is prevented from falling off the outer housing 30, and fixes the inner housing 20 by sandwiching the inner housing 20 between the front holder 70 and the outer housing 30.

Note that the fixation of the inner housing 20 is not limited to the above-described method. For example, the inner housing 20 may be inserted into the opening part 32a of the connector opening unit 32 of the outer housing 30 together with the front holder 70 in a state where the inner housing 20 is placed inside the tubular part 72 of the front holder 70 before the inner housing 20 is inserted into the opening part 32a of the connector opening unit 32 of the outer housing 30.

### Arrangement of Terminals in Connector

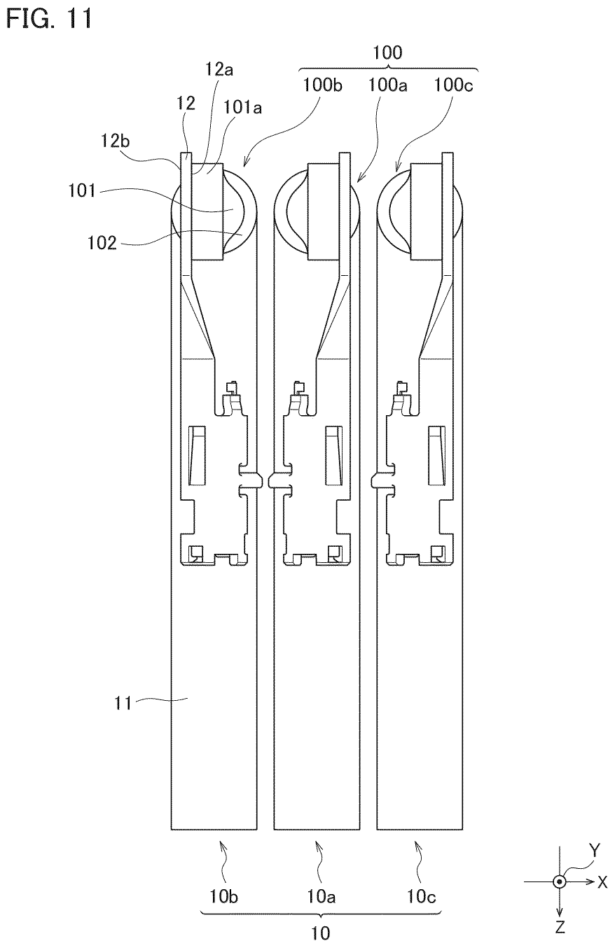

Next, an arrangement of the terminals 10 in the connector 1 will be described with reference to FIG. 4 and FIGS. 9 to 11. FIG. 11 is a diagram illustrating an arrangement of the terminals 10 in the connector 1. An X-direction, a Y-direction, and a Z-direction illustrated in FIG. 11 are the same as the X-direction, the Y-direction, and the Z-direction illustrated in FIG. 2.

In the state where the inner housing 20 is sandwiched and fixed between the outer housing 30 and the front holder 70, in a cross-sectional surface along the X-direction and the Z-direction, the joining units 12 of the three terminals 10 are aligned in a straight line along the X-direction (see FIGS. 10 and 11). In this state, in a cross-sectional surface along the X-direction and the Y-direction, the three terminals 10 are two-tiered along the Y-direction (see FIGS. 4 and 9). In this embodiment, the first terminal receiving unit 21 is arranged in the lower tier in the Y-direction, and the second terminal receiving unit 22 and the third terminal receiving unit 23 are arranged in the upper tier in the Y-direction. In this case, the first terminal receiving unit 21 is arranged at a middle position between the second terminal receiving unit 22 and the third terminal receiving unit 23 in the X-direction.

### Comparative Example

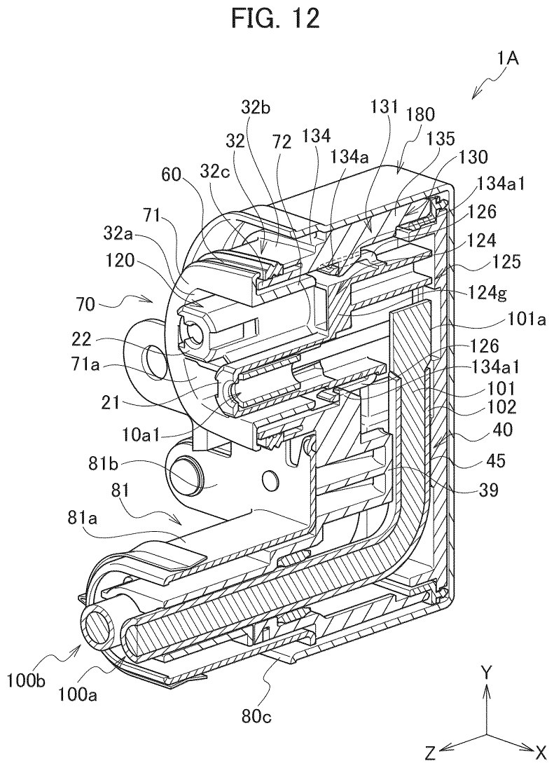

Next, a comparative example will be described with reference to FIG. 12. In a connector 1A according to the present comparative example, an inner housing is locked to an outer housing using a locking mechanism. FIG. 12 is a cross-sectional view of the connector 1A cut along a thickness direction at the center in a width direction of the connector 1A.

An X-direction illustrated in FIG. 12 corresponds to the width direction of the connector 1A. A Y-direction illustrated in FIG. 12 corresponds to a height direction of the connector 1A, and is orthogonal to the X-direction. A Z-direction illustrated in FIG. 12 corresponds to the thickness direction of the connector 1A, and is orthogonal to the X-direction and the Y-direction.

The connector 1A includes a first terminal 10a1, an inner housing 120, an outer housing 130, and an upper shell 180 instead of the first terminal 10a, the inner housing 20, the outer housing 30, and the upper shell 80 in the connector 1 (see FIG. 12). The other components of the connector 1A are the same as the other components of the connector 1, and thus the description of the other components of the connector 1A is omitted.

A distance between the connecting unit 11 and the joining unit 12 in the first terminal 10a1 is longer than a distance between the connecting unit 11 and the joining unit 12 in the first terminal 10a due to the installation of the locking mechanism in the inner housing 120 and the outer housing 130.

The inner housing 120 has a base unit 124 and a reinforcing structure unit 125 instead of the base unit 24 and the reinforcing structure unit 25 in the inner housing 20. The other components of the inner housing 120 are the same as the other components of the inner housing 20, and thus the description of the other components of the inner housing 120 is omitted.

The base unit 124 has a support part 124g instead of the support part 24g of the base unit 24. Unlike the support part 24g, the support part 124g is not provided with the first protruding part 24c and the second protruding part 24d. The other components of the base unit 124 are the same as the other components of the base unit 24, and thus the description of the other components of the base unit 124 is omitted.

A length of the reinforcing structure unit 125 in the Z-direction is larger than a length of the reinforcing structure unit 25 in the Z-direction due to the installation of the locking mechanism in the inner housing 120 and outer housing 130. The reinforcing structure unit 125 has two locked parts 126. One locked part 126 has a root portion that is erected on an upper surface of the reinforcing structure unit 125, and an extension portion that extends from the root portion in the Z-direction. Similarly, the other locked part 126 has a root portion that is erected on a lower surface of the reinforcing structure unit 125, and an extension portion that extends from the root portion in the Z-direction. Thus, each of the locked parts 126 has one end that is a fixing end, and the other end that is a free end. The extending portions of the respective locked parts 126 have locked holes into which claw parts 134a1, which will be described later, are to be inserted.

The outer housing 130 includes a housing main body 131 instead of the housing main body 31 of the outer housing 30. The other components of the outer housing 130 are the same as the other components of the outer housing 30, and thus the description of the other components of the outer housing 130 is omitted.

The housing main body 131 includes a front wall 134 and an annular side wall 135 instead of the front wall 34 and the annular side wall 35 of the housing main body 31. The other components of the housing main body 131 are the same as the other components of the housing main body 31, and thus the description of the other components of the housing main body 131 is omitted.

Lengths of the front wall 134 and the annular side wall 135 in the Z-direction are larger than lengths of the front wall 34 and the annular side wall 35 in the Z-direction due to the installation of the locking mechanism in the inner housing 120 and the outer housing 130. Unlike the communicating hole part 34a of the front wall 34, a communicating hole part 134a of the front wall 134 is not provided with the contacting portion 34a1.

The communicating hole part 134a is provided with one claw part 134a1 that protrudes from an upper inner surface thereof in a direction opposite to the Y-direction. Similarly, the communicating hole part 134a is provided with the other claw part 134a1 that protrudes from a lower inner surface thereof in the Y-direction. The locking mechanism in the connector 1A includes the two locked parts 126 of the inner housing 120 and the two claw parts 134a1 of the outer housing 130.

A length of the upper shell 180 in the Z-direction is larger than a length of the upper shell 80 in the Z-direction corresponding to the lengths of the front wall 134 and the annular side wall 135 of the outer housing 130 in the Z-direction.

In a state where the inner housing 120 is inserted into the opening part 32a of the connector opening unit 32 of the outer housing 130, as the reinforcing structure unit 125 of the inner housing 120 is inserted into the housing main body 31, the two claw parts 134a1 of the outer housing 130 are inserted into the two locked holes of the two locked parts 126 of the inner housing 120. As a result, the inner housing 120 is locked to the outer housing 130.

With this configuration, in the connector 1A, the other locked part 126 is present on the lower surface of the reinforcing structure unit 125 of the inner housing 120. Due to this arrangement, a distance between the connecting unit 11 and the joining unit 12 in the first terminal 10a1 is set longer such that the first terminal 10a1 and the first electric wire 100a joined to the first terminal 10a1 do not interfere with the other locked part 126.

Therefore, in a cross-sectional surface along the X-direction and the Z-direction, the joining unit 12 of the first terminal 10a1 is shifted in the direction opposite to the Z-direction than the joining unit 12 of the second terminal 10b and the joining unit 12 of the third terminal 10c. In contrast, in the connector 1, in the cross-sectional surface along the X-direction and the Z-direction, the joining units 12 of the three terminals 10 are aligned in the straight line along the X-direction (see FIG. 11). Thus, a space for arranging the three terminals 10 in the connector 1A becomes larger than a space for arranging the three terminals 10 in the connector 1.

### Another Comparative Example

Next, another comparative example will be described. In a connector in the other comparative example, each terminal 10 is crimped on the electric wire 100 using a swaging piece. In this case, as illustrated in FIG. 11, if the joining units 12 of the three terminals 10 are aligned in a straight line in a cross-sectional surface along the X-direction and the Z-direction, the swaging piece of the first terminal 10a interferes with the second electric wire 100b on which the second terminal 10b is crimped, due to a short distance between the terminals (see FIG. 4).

Therefore, in the cross-sectional surface along the X-direction and the Z-direction, the joining unit 12 of the first terminal 10a is shifted in a direction opposite to the Z-direction than the joining unit 12 of the second terminal 10b and the joining unit 12 of the third terminal 10c. Thus, a space for arranging the three terminals 10 in the connector in the other comparative example becomes larger than a space for arranging the three terminals 10 in the connector 1.

### Actions and Effect

According to the embodiment, the connector 1 is to be connected to the external connector, and includes the plurality of terminals 10, the inner housing 20, the outer housing 30, and the front holder 70. Each of the terminals 10 extends in the first direction (Z-direction) in which the connector 1 is to be connected to the external connector. Each of the terminals 10 includes the connecting unit 11 to be connected to the external terminal of the external connector, and the joining unit 12 to which the core wire 101 of the electric wire 100 is joined by ultrasonic wave.

The inner housing 20 includes the first terminal receiving unit 21, the second terminal receiving unit 22, and the third terminal receiving unit 23 each of which receives the connecting unit 11 of the corresponding terminal 10 and opens to outside in the first direction (Z-direction). The outer housing 30 includes the housing main body 31 and the connector opening unit 32. The connector opening unit 32 receives the first terminal receiving unit 21, the second terminal receiving unit 22, and the third terminal receiving unit 23 of the inner housing 20, and opens to outside in the first direction (Z-direction). The housing main body 31 is connected to the connector opening unit 32, and receives the joining unit 12 of each of the terminals 10 exposed from the inner housing 20. The front holder 70 fixes the inner housing 20 by sandwiching the inner housing 20 between the front holder 70 and the outer housing 30.

With the above-described configuration, each of the terminals 10 is electrically connected to the corresponding electric wire 100 by ultrasonic joining. Thus, in comparison with the conventional configuration, it is not necessary to provide a swaging piece to each of the terminals 10, and the swaging piece can be omitted. This allows the distance between the terminals 10 can be shortened by the omission of the swaging piece.

With the above-described configuration, the inner housing 20 is sandwiched and fixed between the outer housing 30 and the front holder 70. Thus, in comparison with the conventional configuration, it is not necessary to provide a locking mechanism to lock the inner housing 20 to the outer housing 30, and the locking mechanism can be omitted. This allows the distance between the terminals 10 to be shortened by the omission of the locking mechanism.

Therefore, the connector 1 of the embodiment can reduce the size of the arrangement space for the plurality of terminals 10, thereby reducing the size of the connector 1, and suppress an increase in manufacturing costs.

According to the embodiment, the inner housing 20 further includes the first protruding part 24c, the second protruding part 24d, and the support part 24g. The support part 24g supports the first terminal receiving unit 21, the second terminal receiving unit 22, and the third terminal receiving unit 23. Each of the first protruding part 24c and the second protruding part 24d protrudes outwardly from the support part 24g along a second direction intersecting with the first direction (Z-direction). The first protruding part 24c, the second protruding part 24d, and the support part 24g are received in the housing main body 31 of the outer housing 30.

The outer housing 30 further includes the contacting portion 34a1 that protrudes inwardly from the housing main body 31 along a direction opposite to the second direction, in an interior of a vicinity of an end of the housing main body 31 located in the first direction (Z-direction). In the state where the front holder 70 is locked to the outer housing 30, the front holder 70 presses the first protruding part 24c and the second protruding part 24d of the inner housing 20 against the contacting portion 34a1 of the outer housing 30, by the open end 72a located in a direction opposite to the first direction (Z-direction).

With the above-described configuration, the inner housing 20 can be fixed to the outer housing 30 with a simple configuration without the locking mechanism. Therefore, the increase in manufacturing costs can be further suppressed.

According to the embodiment, in the cross-sectional surface along the first direction (Z-direction) and the width direction (X-direction) of the connector 1, the joining unit 12 of each terminal 10 is aligned with the joining unit 12 of another terminal 10 in a straight line along the width direction (X-direction) of the connector 1.

With the above-described configuration, the distance between the terminals 10 in the width direction (X-direction) of the connector 1 can be minimized. Therefore, the size of the arrangement space for the plurality of terminals 10 can certainly be reduced.

According to the embodiment, in a cross-sectional surface along the width direction (X-direction) and the height direction (Y-direction) of the connector 1, the terminals 10 are arranged in two stages along the height direction (Y-direction) of the connector 1. In the case where one of the terminals 10 is arranged in one of the two stages, a terminal 10 adjacent to the one of the terminals 10 in the width direction (X-direction) of the connector 1 is arranged in the other of the two stages.

With the above-described configuration, in the connector 1, the first terminal receiving unit 21, the second terminal receiving unit 22, and the third terminal receiving unit 23 of the inner housing 20 each of which receives the connecting unit 11 of the corresponding terminal 10, can be alternately arranged in the height direction (Y-direction) of the connector 1. This configuration allows the first terminal receiving unit 21, the second terminal receiving unit 22, and the third terminal receiving unit 23 to be arranged such that parts of the adjacent terminal receiving units overlap in the width direction (X-direction) of the connector 1. Therefore, the size of the arrangement space for the first terminal receiving unit 21, the second terminal receiving unit 22, and the third terminal receiving unit 23 can be reduced, thereby reducing the size of the connector 1.

### Modified Example

In the above-described embodiment, the contacting portion 34a1 is formed continuously along an inner circumference surface of one end of the communicating hole part 34a communicating with the interior of the housing main body 31, but the configuration of the contacting portion 34a1 is not limited to this. For example, a plurality of contacting portions may be formed spaced part from each other along the inner circumferential surface of one end of the communicating hole part 34a communicating with the interior of the housing main body 31. In this case, in the connector 1, at least two contacting portions are set to face the first protruding part 24c and the second protruding part 24d of the base unit 24 of the inner housing 20, respectively.

In the above-described embodiment, the connector 1 is connected to the power supply system of the three-phase motor, but the power supply system is not limited to this. The connector 1 may be connected to a power supply system in which a motor with more than three phases is employed. In this case, since multiple electric wires corresponding to the number of phases are employed, the connector 1 has multiple terminals 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector to be connected to an external connector, comprising:
a plurality of terminals;
an inner housing;
an outer housing; and
a front holder that fixes the inner housing by sandwiching the inner housing between the front holder and the outer housing, wherein
each of the terminals extends in a first direction in which the connector is to be connected to the external connector,
each of the terminals includes a connecting unit to be connected to an external terminal of the external connector, and a joining unit to which a core wire of an electric wire is joined by ultrasonic wave,
the inner housing includes a plurality of first receiving units each of which receives the connecting unit of a corresponding terminal and opens to outside in the first direction, and
the outer housing includes a second receiving unit that receives the plurality of the first receiving units of the inner housing and opens to outside in the first direction, and a third receiving unit that is connected to the second receiving unit and receives the joining unit of each of the terminals exposed from the inner housing.

2. The connector according to claim 1, wherein
the inner housing further includes a support part that supports the plurality of the first receiving unit, and a protruding part that protrudes outwardly from the support part along a second direction intersecting with the first direction,
the support part and the protruding part are received in the third receiving unit of the outer housing,
the outer housing further includes a contacting portion that protrudes inwardly from the third receiving unit along a direction opposite to the second direction, in an interior of a vicinity of an end of the third receiving unit located in the first direction, and
in a state where the front holder is locked to the outer housing, the front holder presses the protruding part of the inner housing against the contacting portion of the outer housing by an end edge of the front holder located in a direction opposite to the first direction.

3. The connector according to claim 1, wherein
in a cross-sectional surface along the first direction and a width direction of the connector, the joining unit of each terminal is aligned with the joining unit of another terminal in a straight line along the width direction of the connector.

4. The connector according to claim 3, wherein
in a cross-sectional surface along the width direction and a height direction of the connector, the terminals are arranged in two stages along the height direction of the connector, and
in a case where one of the terminals is arranged in one of the two stages, a terminal adjacent to the one of the terminals in the width direction of the connector is arranged in another of the two stages.
